(19) United States
(12) Patent Application Publication
(10) Pub. No.: US 2021/0381288 A1
(43) Pub. Date: Dec. 9, 2021

(54) DOOR APPARATUS

(71) Applicants: YOSEF POSTAVSKII, JERUSALEM (IL); ARON PRYS, JERUSALEM (IL); ARYE FRIEDNER, JERUSALEM (IL)

(72) Inventors: YOSEF POSTAVSKII, JERUSALEM (IL); ARON PRYS, JERUSALEM (IL); ARYE FRIEDNER, JERUSALEM (IL)

(21) Appl. No.: 17/336,355

(22) Filed: Jun. 2, 2021

(30) Foreign Application Priority Data
Jun. 7, 2020 (IL) 275166

(51) Int. Cl. E05C 9/06; E05B 63/00; E05B 63/14; E05C 9/08; E05C 9/24

(52) U.S. Cl. CPC E05C 9/063; E05B 63/0052; E05B 63/14; E05C 9/08; E05Y 2201/604; E05Y 2201/722; E05Y 2201/718; E05Y 2900/132; E05C 9/24

(57) ABSTRACT

A door apparatus, including a first lintel, including a first slideable bolt, and a first rotatable cogged wheel, being interlaced with the first slideable bolt, and a door, including a second bolt being slideable by key operation, to interlace the first rotatable cogged wheel to rotate thereof, thereby to slide the first slideable bolt, and a first depression, for housing the first slideable bolt of the first lintel, thereby locking thereof to the door, thereby massive locking allows reducing the second bolt of the door.

### CROSS-REFERENCE TO RELATED APPLICATIONS

This application claims the benefit of priority from Israel Patent Application No. 275166 filed Jun. 7, 2020, the disclosure of which is incorporated herein by reference.

### TECHNICAL FIELD

The invention relates to the field of doors. More particularly, the invention relates to a door and lintels, for providing improved locking.

### BACKGROUND

Doors are limited in their locking strength due to their requirement of moving.

U.S. Pat. No. 909,462 to Louis discloses a bolted door. However U.S. Pat. No. 909,462 does not disclose doubled locking by two bolts.

There is a long felt need to provide a solution to the above-mentioned and other problems of the prior art.

### SUMMARY

A door apparatus, including:
a lintel, including a slideable bolt; and
a door, including a bolt being slideable by key operation, to slide the slideable bolt.

### BRIEF DESCRIPTION OF THE DRAWINGS

Embodiments, features, and aspects of the invention are described herein in conjunction with the following drawings:

FIG. 1 is a front view of a door according to one embodiment of the invention.

FIG. 2 magnifies the top corner of the door apparatus of FIG. 1.

FIG. 3 is a top view of the door apparatus of FIG. 1 along the door including the two vertical lintels, at the height of the handle of FIG. 1, prior to locking the door.

FIG. 4 is the top view of the door apparatus of FIG. 1 along the door including the two vertical lintels, at the height of the handle of FIG. 1, upon locking the door.

FIG. 5 is the top view of the door of FIG. 1, at a height rather than that of the handle of FIG. 1 upon locking the door.

FIG. 6 depicts the door and the bolts without the lintels.

FIG. 7 is a side view of the door apparatus of FIG. 1 at the top, showing the width thereof, prior to locking the door.

FIG. 8 is a side view of the door apparatus of FIG. 1 at the top, showing the width thereof, upon locking the door.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

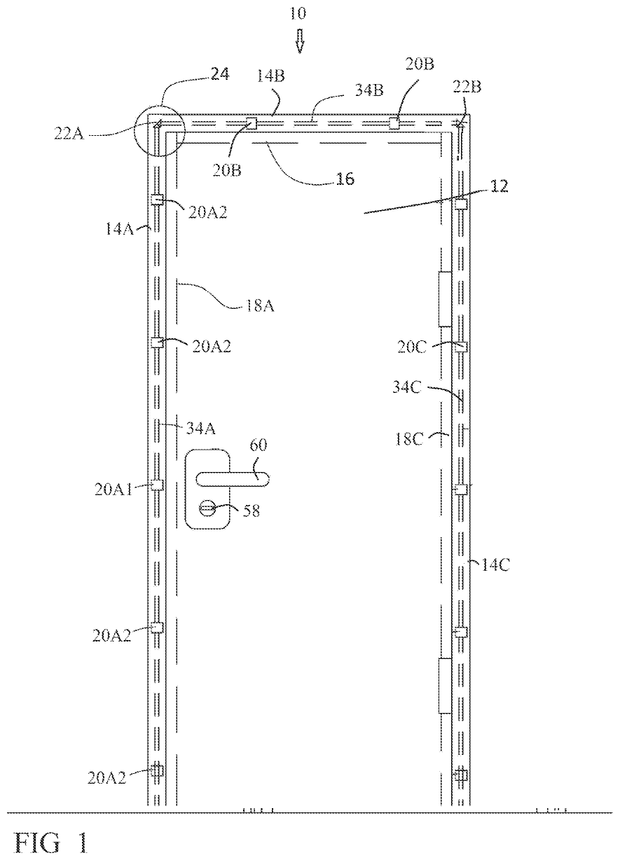

FIG. 1 is a front view of a door according to one embodiment of the invention.

A door apparatus 10 according to one embodiment of the invention, includes a door 12 including a handle 60 and a lock 62; vertical lintels 14A and 14C; and a horizontal top lintel 14B.

Vertical lintel 14A houses a vertical rotatable rod 34A; and horizontal lintel 14B houses a vertical rotatable rod 34B.

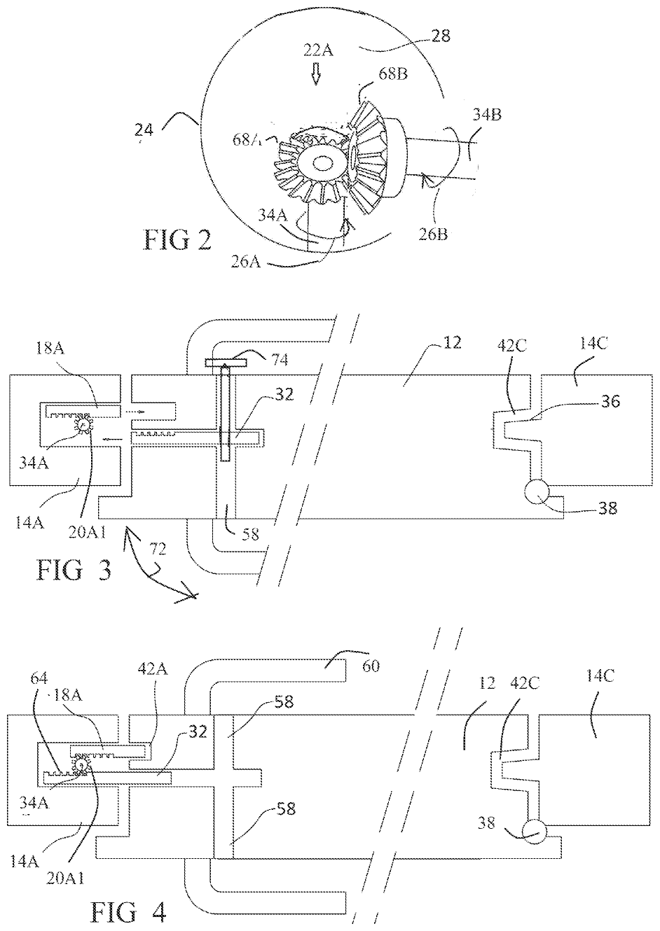

FIG. 2 magnifies the top corner of the door apparatus of FIG. 1.

Rotation of vertical rotatable rod 34A rotates horizontal rotatable rod 34B through a motion transfer member 22A, such as a right angle rotation convertor, which may typically include 45 degrees cogged wheels 68A and 68B interlaced with one another.

Rotation of horizontal rotatable rod 34B may rotate vertical rotatable rod 34C through a right angle rotation convertor 22B.

FIG. 3 is a top view of the door apparatus of FIG. 1 along the door including the two vertical lintels, at the height of the handle of FIG. 1, prior to locking the door.

A key 74 inserted into a cylinder 58 of a lock of door 12 is configured to slide a bolt 32, similar to a prior art door.

FIG. 4 is the top view of the door apparatus of FIG. 1 along the door including the two vertical lintels, at the height of the handle of FIG. 1, upon locking the door.

Rotating of the key (not shown) slides bolt 32 towards outside the body 12 of the door.

Vertical lintel 14A includes a rotatable cogged wheel 20A1, and a slideable cogged bolt 18A, interlaced with cogged wheel 20A1.

Bolt 32 of door 12 includes cogs 64 for allowing interlacing bolt 32 with cogged wheel 20A1 for rotating thereof, for sliding cogged bolt 18A of vertical lintel 14A, from vertical lintel 14A towards door 12.

Cogged wheel 20A1 extends from a rotational vertical rod 34A fixed thereto, thus being rotated therewith.

Referring again to FIG. 1, a plurality of cogged wheels 20A2 extend from rotational vertical rod 34A.

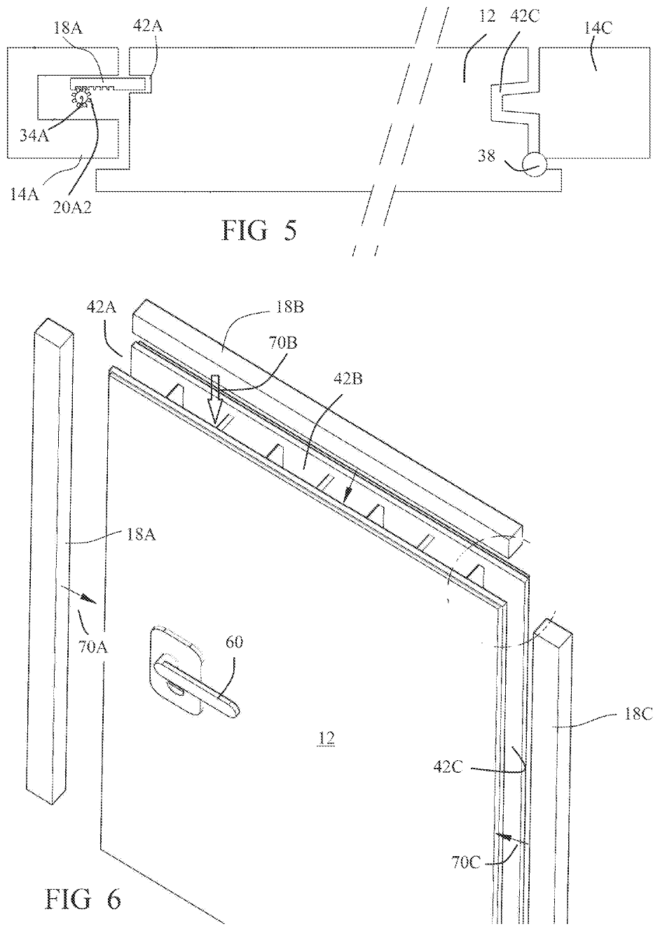

FIG. 5 is the top view of the door of FIG. 1, at a height rather than that of the handle of FIG. 1 upon locking the door.

Vertical bolt 18A is cogged as well at the various heights of cogged wheels 20A2 and interlaced therewith.

Thus, the rotation of vertical rod 34A by cogged wheel 20A1, rotates as well cogged wheels 20A2. Each of cogged wheels 20A1 and 20A2 slides bolt 18A at the height of that cogged wheel, thus providing together equal horizontal sliding at different heights of bolt 18A.

FIG. 6 depicts the door and the bolts without the lintels.

Bolt 18A extending vertically along the entire height of vertical lintel 14A (of FIG. 1) is slideable 70A for being inserted into a vertical depression 42A of door 12 extending vertically along the entire height thereof.

Bolt 18A is slideable by rotation of cogged wheels 20A1 and 20A2 (of FIG. 1), being disposed therealong and being fixed one to the other through vertical rotatable rod 34A (of FIG. 1),

Insertion 70A of bolt 18A provides an advantaged bolting due to eliminating the weight of bolt 18A and of the mechanism of its sliding from door 12, thus door 12 is lightweight while being massively lockable.

As explained above, rotation of vertical rotatable rod 34A rotates horizontal rotatable rod 34B.

A horizontal bolt 18B is vertically slideable 70B by rotation of cogged wheels 20B (of FIG. 1), being disposed along horizontal rotatable rod 34B and being fixed thereto (of FIG. 1).

Horizontal bolt 18B extending along the entire length of horizontal lintel 14B (of FIG. 1) is slideable 70B for being inserted into a horizontal depression 42B of door 12 extending horizontally along the entire length thereof.

As explained above, rotation of horizontal rotatable rod 34B may rotate vertical rotatable rod 34C.

A vertical bolt 18C may be slideable 70C by rotation of cogged wheels 20C (of FIG. 1), being disposed along vertical rotatable rod 34C and being fixed thereto (of FIG. 1).

Vertical bolt 18C extending along the entire length of vertical lintel 14C (of FIG. 1) may be slideable 70C for being inserted into a vertical depression 42C of door 12 extending vertically along the entire length thereof.

Referring again to FIG. 3, in contrast to vertical lintel 14A, a stationary vertical protrusion 36 of vertical lintel 14C may be inserted into vertical depression 42C of door 12 by rotation 72 of door 12 about its hinge 38, instead of inserting vertical bolt 18C.

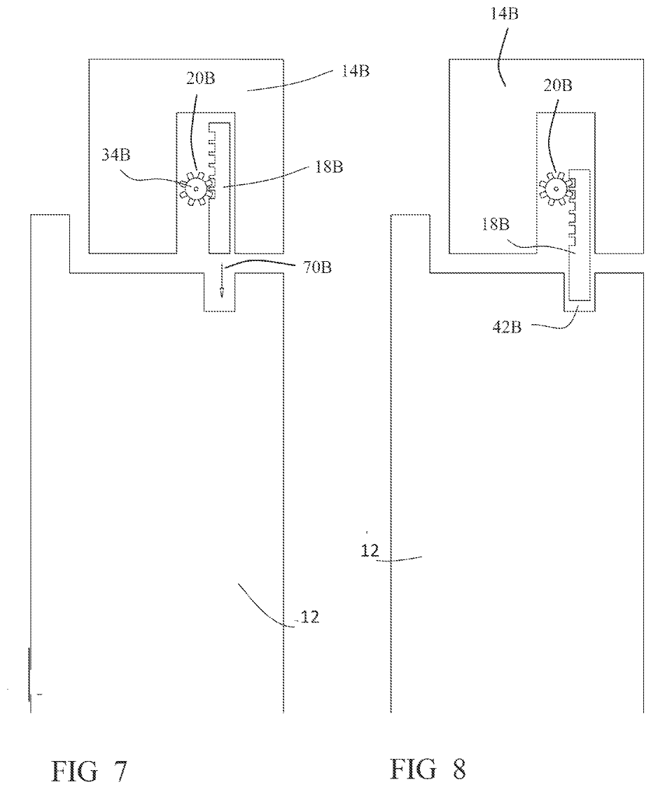

FIG. 7 is a side view of the door apparatus of FIG. 1 at the top, showing the width thereof, prior to locking the door.

FIG. 8 is a side view of the door apparatus of FIG. 1 at the top, showing the width thereof, upon locking the door.

As explained above, rotation of vertical rotatable rod 34A (FIG. 1) rotates horizontal rotatable rod 34B. Horizontal bolt 18B is vertically slideable 70B by rotation of cogged wheels 20B (of FIG. 1), being disposed along horizontal rotatable rod 34B and being fixed thereto.

Thus, in one aspect, the invention is directed to a door apparatus (10), including:
a first lintel (14A), including:
a first slideable bolt (18A); and
a first rotatable cogged wheel (20A1), being interlaced with the first slideable bolt (18A); and
a door (12), including:
a second bolt (32) being slideable by key (74) operation, to interlace the first rotatable cogged wheel (20A1) to rotate (26A) thereof, thereby to slide (70A) the first slideable bolt (18A); and
a first depression (42A), for housing the first slideable bolt (18A) of the first lintel (14A), thereby locking thereof to the door (12),

thereby massive locking allows reducing weight of the second bolt (32) of the door (12) and reducing the mechanism thereof.

The door apparatus (10) may further include:
a second lintel (14B), including:
a third slideable bolt (18B); and
a second rotatable cogged wheel (20B), being interlaced with the third slideable bolt (18B); and
a motion transfer member (22A), for transferring the rotation (26A) of the first rotatable cogged wheel (20A1) to rotation (26B) of the second rotatable cogged wheel (20B),

wherein the door (12) further includes a second depression (42A), for housing the third slideable bolt (18B) of the second lintel (14B),

thereby the third slideable bolt (18B) of the second lintel (14B) is configured to lock thereof to the door (12).

The door apparatus (10) may further include:
a third lintel (14C), including a stationary protrusion (36),

wherein the door (12) further includes a third depression (42C), for housing the stationary protrusion (36) of the third lintel (14C),

thereby the stationary protrusion (36) of the third lintel (14A) is configured to insert the third depression (42C) upon rotating (72) the door (12) about a hinge (38) thereof,

thereby strengthening the locking.

The first lintel (14A) may further include:
a rod (34A), extending along the first lintel (14A), and being fixed to the first rotatable cogged wheel (20A1); and
at least a third rotatable cogged wheel (20A2) being fixed to the rod (34A) parallel to the first rotatable cogged wheel (20A1), and being interlaced with the first slideable bolt (18A),

thereby concurrently sliding a plurality of locations of the first slideable bolt (18A).

The first slideable bolt (18A) preferably extends along most of the first lintel (14A); the second slideable bolt (18A) preferably extends along most of the second lintel (14B); and the protrusion (36) of the third lintel (14C) preferably extends along most of the third lintel (14C).

In the figures and/or description herein, the following reference numerals (Reference Signs List) have been mentioned:

numeral 10 denotes the door apparatus according to one embodiment of the invention;

12: door;

14A,14B,14C: lintels;

18A,18B,18C: slideable bolts;

20A1,20A2,20B,20C: cogged wheels;

22A,22B: motion transfer members;

24: zone;

26A: rotation of rod 34A;

26B: rotation of rod 34B;

32: bolt of door 12, slideable by key 74;

34A,34B,34C: rods, for transferring motion between cogged wheels;

36: elongated protrusion of lintel 14C;

38: hinge of door 12;

42A,42B,42C: elongated depressions in the thickness of door 12;

58: cylinder of lock;

60: handle;

64: cogs;

70A,70B,70C: sliding of bolts;

68A,68B: cogged wheels;

74: key;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A door apparatus, comprising:
a first lintel, comprising
a first slideable bolt, and
a first rotatable cogged wheel, being interlaced with said first slideable bolt; and
a door, comprising
a second bolt being slideable by key operation, to interlace said first rotatable cogged wheel to rotate thereof, thereby to slide said first slideable bolt, and
a first depression, for housing said first slideable bolt of said first lintel, thereby locking thereof to said door,
thereby massive locking allows reducing weight of said second bolt of said door.

2. The door apparatus according to claim 1, further comprising:
a second lintel, comprising
a third slideable bolt, and
a second rotatable cogged wheel, being interlaced with said third slideable bolt; and
a motion transfer member, for transferring said rotation of said first rotatable cogged wheel to rotation of said second rotatable cogged wheel,
wherein said door further comprises a second depression, for housing said third slideable bolt of said second lintel,
thereby said third slideable bolt of said second lintel is configured to lock thereof to said door.

3. The door apparatus according to claim 1, further comprising:
a third lintel, comprising a stationary protrusion,
wherein said door further comprises a third depression, for housing said stationary protrusion of said third lintel,
thereby said stationary protrusion of said third lintel is configured to insert said third depression upon rotating said door about a hinge thereof,
thereby strengthening said locking.

4. The door apparatus according to claim 1, wherein said first lintel further comprises:
a rod, extending along said first lintel, and being fixed to said first rotatable cogged wheel; and
at least a third rotatable cogged wheel being fixed to said rod parallel to said first rotatable cogged wheel, and being interlaced with said first slideable bolt,
thereby concurrently sliding a plurality of locations of said first slideable bolt.

5. The door apparatus according to claim 1, wherein said first slideable bolt extends along most of said first lintel.
